(19) United States
(12) Patent Application Publication
(10) Pub. No.: US 2020/0232816 A1
(43) Pub. Date: Jul. 23, 2020

(54) Distance Measurement Module for Measuring a Distance in a Bearing, Sensor Set, and Bearing Assembly

(71) Applicant: Schaeffler Technologies AG & Co. KG, Herzogenaurach (DE)

(72) Inventors: Philipp Hörning, Bamberg (DE); Frank Benkert, Waigolshausen (DE); Christoph Weeth, Werneck (DE)

(73) Assignee: Schaeffler Technologies AG & Co. KG, Herzogenaurach (DE)

(21) Appl. No.: 16/336,502

(22) PCT Filed: Sep. 27, 2017
(86) PCT No.: PCT/DE2017/100825

§ 371 Date: Mar. 26, 2019

(30) Foreign Application Priority Data
Nov. 4, 2016 (DE) 102016221610.4

(51) Int. Cl. G01D 5/14; F16C 41/00

(52) U.S. Cl. CPC G01D 5/14; F16C 2233/00; F16C 41/008

(57) ABSTRACT

A bearing, such as a roller bearing, linear bearing, or a slide bearing, is used to support a first machine element relative to a second machine element. A distance measurement module is integrated within the bearing or near the bearing. The distance measurement module is used for measuring a spatial distance and possibly other physical variables during operation of the mechanical bearing. The distance to be measured is preferably specified between an inner ring and an outer ring of the bearing. The distance to be measured can also represent another physical variable, such as a force derived from the distance.

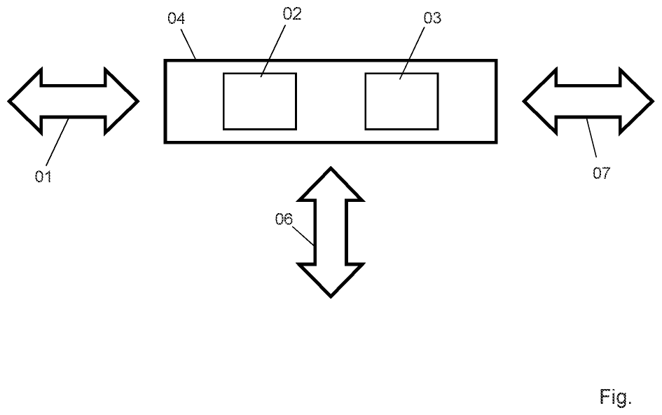

### CROSS-REFERENCE TO RELATED APPLICATIONS

This application is the U.S. National Phase of PCT Appln. No. PCT/DE2017/100825 filed Sep. 27, 2017, which claims priority to DE 102016221610.4 filed Nov. 4, 2016, the entire disclosures of which are incorporated by reference herein.

### TECHNICAL FIELD

The present disclosure concerns a distance measurement module for measuring a distance in or on a mechanical bearing. In addition, the disclosure concerns a sensor set in the form of a kit, based on which the mechanical bearing for sensor bearings can be developed. The disclosure also concerns a bearing assembly in the form of a sensor bearing.

### BACKGROUND

DE 101 36 438 A1 discloses a sensor arrangement in a roller bearing, in which a plurality of sensor elements is integrated in bearing shells of the roller bearing. The sensor elements can be connected by means of a digital bus.

From DE 10 2009 037 424 A1, a bearing assembly with a lubricant sensor is known, which sends information about the state of the lubricant to a central receiving station.

DE 102 36 790 C1 reveals an electrical switching unit with a plurality of poles, in which each pole comprises at least one connecting contact.

From DE 100 64 420 B4, a device for decentralized detection and analysis of physical events is known, in which measuring elements are programmable over an internal bus system.

DE 100 54 069 A1 reveals a building controller with a base system and with a logic system. The base system comprises at least one active module, whereas the logic system comprises at least one logic module.

DE 10 2009 021 469 A1 reveals a sensor bearing unit comprising a roller bearing with a sensor housing disposed on a bearing ring with an integrated sensor device for detecting bearing operating states. The sensor housing is embodied as an adapter ring. The adapter ring is dimensioned so that the radial or axial dimensions of the sensor bearing unit are less than or equal to those of a ball bearing with the same bearing capacity.

DE 10 2012 202 522 A1 describes a sensor bearing with a roller bearing. The roller bearing comprises an inner ring, an outer ring and roller bodies disposed in between. Furthermore, the sensor bearing contains at least one transducer for measuring the forces acting on the roller body and a communications device that enables an exchange of data between the transducer and a signal receiver.

### SUMMARY

It is desired to be able to flexibly augment mechanical bearings for distance measurement. This is achieved by a distance measurement module, by a sensor set, and by a bearing assembly.

The distance measurement module is used for measuring a spatial distance in or on a mechanical bearing. The bearing is used to support a first machine element relative to a second machine element. The mechanical bearing is preferably a roller bearing, a linear bearing or a slide bearing. The distance measurement module is embodied to be integrated within the bearing or near the bearing, whereby the bearing is augmented to be a sensor bearing. In the sensor bearing, distance and possibly other physical variables to be measured can be measured on the mechanical bearing with the distance measurement module during the operation of the mechanical bearing. The distance to be measured is preferably specified between an inner ring and an outer ring of the bearing. The distance to be measured can also represent another physical variable, such as for example a force. In this respect, the distance measurement module can also be used for measuring one or more physical variables derived from the distance. The distance to be measured is preferably proportional to one of the other physical variables.

The distance measurement module comprises a sensor for measuring the distance. Said geometric distance is a bearing state variable. The distance can be formed within the bearing, between a component of the bearing and an external element or between elements in the surroundings of the bearing.

The distance measurement module comprises an electrical interface for outputting a distance measurement signal to an infrastructure module. The distance measurement signal is obtained directly or indirectly with the sensor. The distance measurement signal is preferably an output signal of the sensor or alternatively and preferably the output signal of the sensor pre-processed by measurement signal pre-processing. The electrical interface is preferably embodied for data transmission in order to output the distance measurement signal in the form of digital data. Furthermore, the electrical interface is preferably embodied for transferring a supply voltage for the electrical supply of the distance measurement module. Furthermore, the electrical interface is preferably embodied for transferring control data for controlling the distance measurement module. The infrastructure module is embodied for carrying out communications tasks and/or for storing and/or processing the distance measurement signal. The infrastructure module comprises an electrical interface, via which it can be electrically connected to the distance measurement module. The infrastructure module is preferably embodied to be disposed in the bearing.

The distance measurement module comprises a mechanical interface for the mechanical disposition of the distance measurement module in a module receptacle of the bearing. Thus, the distance measurement module can be integrated within the bearing. The distance measurement module can preferably be fastened in the module receptacle of the bearing. The distance measurement module can preferably be non-reversibly fastened in the module receptacle of the bearing.

A particular advantage of the distance measurement module is that it enables flexible augmentation of a mechanical bearing for distance measurement, by which condition monitoring of the bearing or a system surrounding the bearing is enabled.

The distance measurement module preferably comprises a housing, in which the sensor is disposed and on which the mechanical interface is formed. The mechanical interface is preferably defined by the external shape of the housing. Furthermore, the mechanical interface preferably comprises fastening elements on the housing.

The sensor is preferably formed by an eddy current sensor. However, other measurement principles can also be used for measuring the distance.

The eddy current sensor preferably comprises a resonant circuit, which is preferably formed by a capacitor and by a coil. The eddy current sensor also preferably comprises an oscillator for stimulating the resonant circuit.

The eddy current sensor is preferably embodied for measuring the distance from an electrically conductive surface. The electrically conductive surface can be within the bearing or outside the bearing and defines an end point of the distance to be measured.

The electrically conductive surface is preferably formed on a ring. The ring preferably consists of a metal. The ring is preferably embodied for attachment to a bearing ring of the bearing. The electrically conductive surface is preferably formed on the shell surface or one of the side surfaces of the ring.

Furthermore, preferred embodiments of the distance measurement module comprise a signal processing unit that can be embodied for different functions. The signal processing unit is preferably embodied for measurement signal pre-processing of the output signal of the sensor, so that the signal processing unit is embodied to output the distance measurement signal to the electrical interface. The measurement signal pre-processing preferably consists of forming an average value and/or an offset correction. The signal processing unit is preferably also embodied for encoding the digital distance measurement signal in order to enable the transfer of the digital distance measurement signal by means of a data bus embodied in the electrical interface. The signal processing unit is preferably embodied for the correction of measurement errors of the sensor. For this purpose, the signal processing unit is preferably embodied for correction of the measurement errors dependent on a temperature and/or on static and/or dynamic electromagnetic interference fields. The signal processing unit is preferably embodied for controlling the resonant circuit in the eddy current sensor.

The signal processing unit is also preferably embodied to linearize the output signal. The signal of the sensor is then processed such that the generated output signal is linearly proportional to the distance measured by the sensor.

The signal processing unit is preferably disposed together with the sensor in the housing. The distance measurement module thus forms a compact module that already enables the signal processing.

The sensor set is provided for mechanical bearings and comprises a number of modules, with which at least one mechanical bearing can be expanded to a sensor bearing. The sensor bearing is the mechanical bearing augmented by a sensor arrangement including the necessary components for the operation of the sensor arrangement, so that at least one physical variable can be measured on the mechanical bearing during the operation of the mechanical bearing. To expand the mechanical bearing to the sensor bearing, a plurality of modules is to be selected from the sensor set and disposed on the mechanical bearing. In this respect, the sensor set is a kit. The mechanical bearing is preferably a roller bearing. The physical variables to be measured include at least one distance or a physical variable derived therefrom.

The modules of the sensor set comprise a number of function modules for measuring bearing state variables and/or for triggering and/or activating specified events under specified conditions. The different function modules each comprise an electrical interface, regarding which they are compatible. The different function modules are thus interchangeable relative to the electrical interface thereof. At least one of the function modules is formed by the distance measurement module. Preferably, said function module is formed by a preferred embodiment of the distance measurement module.

Furthermore, the modules of the sensor set comprise a number of infrastructure modules for implementing communications tasks and/or for storing and/or processing specified and/or recorded data. The different infrastructure modules each comprise an electrical interface, via which they are interoperable with at least several of the function modules, so that the different infrastructure modules contribute to ensuring the operation of the respective function modules. At least one of the infrastructure modules is formed by a signal analysis unit for analysis of the distance measurement signal. The signal analysis unit thus has a functional relationship with the distance measurement module. Whereas the distance measurement module preferably provides the distance measurement signal in the form of pre-processed raw data, the signal analysis unit is preferably used for analysis of the pre-processed raw data. Said two functions are thus not implemented by a single module, but by two modules, i.e. in two different physical units. The electrical interface of the signal analysis unit is at least interoperable with the electrical interface of the distance measurement module.

One particular advantage of the sensor set is that it enables the flexible expansion of a mechanical bearing, which enables condition monitoring of the bearing or a system surrounding the bearing.

A further advantage of the sensor set is that it enables the flexible expansion of a mechanical bearing, enabling new or improved functionalities of the system containing the bearing, for example by the bearing augmented by the sensor set providing control variables to the system.

In the case of particularly preferred embodiments of the sensor set, the signal analysis unit is also embodied for analysis of signals of other different function modules. It is thus a common signal analysis unit.

With preferred embodiments of the sensor set, the distance measurement module and all other function modules each comprise an electrical interface, regarding which they are compatible, so that all function modules are interchangeable regarding the electrical connection thereof.

With preferred embodiments of the sensor set, the distance measurement module and at least one of the other function modules each comprise an external form, in terms of which they are compatible. Thus, the distance measurement module and the at least one of other function modules are interchangeable within a bearing installation space provided for this in the bearing. The distance measurement module and all other of the function modules each preferably comprises an external form, in terms of which they are compatible.

With preferred embodiments of the sensor set, the distance measurement module and at least one other of the function modules each comprises at least one fastening element, regarding which they are compatible. Thus, the distance measurement module and the at least one other of the function modules can each be fastened within a module receptacle provided for this in the bearing. The at least one fastening element is for example formed by a pin or by a bolt. The distance measurement module and all others of the function modules each preferably comprises at least one fastening element, in respect of which they are compatible.

With preferred embodiments of the sensor set, the distance measurement module and at least one other of the function modules are each interoperable with the signal analysis unit, so that they can be operated together or are even interchangeable. The distance measurement module and all others of the function modules are each preferably interoperable with the signal analysis unit.

Furthermore, the modules of the sensor set preferably comprise a number of supply management modules for supplying bearing components, wherein the bearing components to be supplied are formed by modules of the sensor set and/or by other components of the mechanical bearing. At least some of the supply management modules are preferably different. The group of supply management modules preferably comprises at least one module for supplying sensor bearing components with electrical power. The at least one module for supplying electrical power is preferably embodied for supplying the distance measurement module and/or the signal analysis unit with electrical power. The at least one module for supplying electrical power is preferably formed by a voltage supply module, by an accumulator module, by a battery module, by a capacitor module, by a power management module, by an energy harvesting module, by a generator module, by a signal and power transmission module and/or by a power interface module for external equipment.

According to an advantageous embodiment, the other function modules are embodied for measuring bearing state variables, such as acceleration, revolution rate, temperature, force, rotation angle and/or lubricant quality. Furthermore, the other function modules can be embodied for actuating lubricant pumps or for the visual or acoustic display of messages. The group of further function modules preferably also contains a service module, which triggers corresponding activities under specified conditions.

At least one further infrastructure module is preferably embodied for electrical connection of the modules to a connecting medium. Said connecting medium is preferably an interface module that adapts the electrical interface to the respective environment, for example an interface with currents between 4 mA and 20 mA or Ethernet. Furthermore, the infrastructure modules preferably contained within the sensor set include a radio module, an RFID module, an NFC module, a memory module, a cable module, an identification module and/or an operating hours module. In the memory module, the measurement data detected by the function modules can be stored, for example. Moreover, the memory module can also be used for storing reference data.

According to an advantageous embodiment, the connecting medium is a bus system. The connecting medium can also be a wired bus system.

At least one of the infrastructure modules is preferably embodied for the wireless exchange of data.

The modules are preferably provided for a roller bearing, so that the roller bearing can be at least partly integrated within a roller bearing space. In principle, the modules can be provided for a linear bearing or for a rotary bearing.

The bearing assembly comprises a mechanical bearing for supporting a machine element. Moreover, the bearing assembly comprises at least one of the function modules of the sensor set. The bearing assembly preferably comprises at least two of the function modules of the sensor set. In any case, the bearing assembly comprises the distance measurement module. Therefore, one function module of the bearing assembly or at least one of the plurality of function modules of the bearing assembly is embodied by the distance measurement module. Furthermore, the bearing assembly comprises at least one of the infrastructure modules of the sensor set. The at least one infrastructure module comprises at least the signal analysis unit. The electrical interface of the distance measurement module is electrically connected to the electrical interface of the signal analysis unit, so that the pre-processed distance measurement signal is fed to the signal analysis unit.

The bearing assembly preferably also comprises the features that are specified in connection with the distance measurement module and with the sensor set and the preferred embodiments thereof.

The bearing assembly is embodied by the distance measurement module and by the signal analysis unit preferably for condition monitoring of the bearing or a system surrounding the bearing.

Moreover, the bearing assembly is embodied by the distance measurement module and by the signal analysis unit preferably for the provision of control variables to the system surrounding the bearing.

The modules of the bearing assembly can be coupled with systems disposed outside the bearing when required. For example, the coupling of individual modules to external power supply systems or external devices can be carried out for data processing and data analysis. The system disposed outside the bearing can also contain one or more of the infrastructure modules of the sensor set when required, such as for example the signal analysis unit.

### DETAILED DESCRIPTION

Further details, advantages and developments arise from the following description of a preferred embodiment, with reference to the drawing.

The single FIGURE shows a schematic diagram of a preferred embodiment of a distance measurement module for measuring a distance 01 in a mechanical bearing (not shown). The distance measurement module comprises a sensor 02 for measuring the distance and a signal processing unit 03 for measurement signal pre-processing of an output signal of the sensor 02. The sensor 02 and the signal processing unit 03 are disposed in a housing 04.

The housing 04 comprises a mechanical connection 06, by means of which it can be installed in or on the mechanical bearing (not shown).

The distance measurement module comprises a power supply and communications connection 07, by means of which it is supplied with electrical voltage and is controlled and by means of which a distance measurement signal output by the signal processing unit 03 can be transferred to outside the distance measurement module.

### REFERENCE CHARACTER LIST

01 distance
02 sensor
03 signal processing unit
04 housing
06 mechanical connection
07 power supply and communications connection

1. A distance measurement module for measuring a distance in or on a mechanical bearing, comprising:
a sensor for measuring the distance, the distance being a bearing state variable;
an electrical interface for outputting a distance measurement signal to an infrastructure module; and
a mechanical interface for mechanical disposition of the distance measurement module in a module receptacle of the bearing.

2. The distance measurement module of claim 1, further comprising a housing in which the sensor is disposed and on which the mechanical interface is embodied.

3. The distance measurement module of claim 1 wherein the sensor is an eddy current sensor.

4. The distance measurement module of claim 3 wherein the eddy current sensor comprises a resonant circuit and an oscillator for stimulating the resonant circuit.

5. The distance measurement module of claim 3 wherein the eddy current sensor measures the distance from an electrically conductive surface.

6. The distance measurement module of claim 5 wherein the electrically conductive surface is formed on a ring.

7. The distance measurement module of claim 1 further comprising a signal processing unit configured for measurement signal pre-processing of an output signal of the sensor in order to output the distance measurement signal.

8. The distance measurement module of claim 2 further comprising a signal processing unit disposed in the housing.

9. A sensor set for a mechanical bearing, comprising:
a plurality of function modules for measuring bearing state variables or for triggering or activating specified events under specified conditions, wherein at least one of the function modules is a distance measurement module as claimed in claim 1; and
a plurality of infrastructure modules for implementing communications tasks or for storing or processing specified or recorded data, wherein the infrastructure modules each comprise an electrical interface, by means of which they are interoperable with at least some of the function modules, and wherein at least one of the infrastructure modules is a signal analysis unit for the analysis of the distance measurement signal of the distance measurement module.

10. A bearing assembly, comprising:
a mechanical bearing for supporting a machine element;
a distance measurement module for measuring a distance as claimed in claim 1; and
a signal analysis unit wherein the electrical interface of the distance measurement module is electrically connected to an electrical interface of the signal analysis unit.

11. The distance measurement module of claim 1 further comprising a signal processing unit configured for encoding of the digital distance measurement signal for transfer by means of a data bus embodied in the electrical interface.

12. The distance measurement module of claim 1 further comprising a signal processing unit configured for correction of measurement errors of the sensor.

13. The distance measurement module of claim 4 further comprising a signal processing unit configured for control of the resonant circuit in the eddy current sensor.

14. The distance measurement module of claim 1 further comprising a signal processing unit configured for linearization of the output signal.
